(19) United States
(12) Patent Application Publication
(10) Pub. No.: US 2011/0167668 A1
(43) Pub. Date: Jul. 14, 2011

(54) DRYING PROCESS FOR DRYING LIGNITE BY SWASHING DUST COLLECTING AND WASHING

(75) Inventors: Xu ZHAO, Gansu (CN); Yinghai LI, Gansu (CN); Yan DOU, Gansu (CN); Yongfei YUE, Gansu (CN); Zhongfu ZHAN, Gansu (CN); Jinwen SHI, Gansu (CN)

(73) Assignees: Tianhua Institute of Chemical Machinery and Automation, Gansu (CN); National Engineering Technology Research Center of Drying Technology & Equipment, Gansu (CN); Lanzhou Ruide Drying Technology Co. Ltd., Gansu (CN)

(21) Appl. No.: 12/987,768

(22) Filed: Jan. 10, 2011

(30) Foreign Application Priority Data
Jan. 11, 2010 (CN) 201010046316.6

(51) Int. Cl. F26B 7/00; F26B 3/02

(52) U.S. Cl. 34/427

(57) ABSTRACT

The present invention relates to A drying process for drying lignite by swashing dust collection and washing, comprising steps of: conveying wet powdered coal into a dryer by a feed belt so as to be dried; introducing hot steam for drying via a rotary joint at an outlet end of the dryer and into a heat exchange tube via a steam chamber; having the wet powdered coal contact and heat exchange with a steam pipe and dried; discharging the dried coal from an discharge port and conveying the dried coal to a subsequent station by a discharging belt; introducing condensed water resulted from steam heat exchange into a condensate pot via a rotating joint and then conveying the condensed water to a next station via a condensate pump; performing a primary dust collecting in a bin at a tail end of the dryer on waste gas produced during the drying process, discharging the waste gas from a top end of the bin and the introducing the waste gas into a swashing dust collector; discharging waste liquid resulted from washing the waste gas from a bottom of the swashing dust collector, conveying the waste liquid discharged from the swashing dust collector via a waste liquid pump. In the present invention, lignite is dried with steam latent heat, and the dried waste gas is washed by a gravity settlement and swashing dust collection so as to assure that the waste gas is discharged after reaching a standard value and avoid the risk of taking fire and explosion occurred in a dry-type dust collecting way.

### FIELD OF THE INVENTION

The present invention relates to a drying method for drying lignite, and more particularly to a drying process for drying high moisture lignite by swashing dust collection and washing, and may be applied to a drying process of other fine coal.

### BACKGROUND OF THE INVENTION

The characteristics of lignite are as follows:

1. Lignite is a high-moisture and high-volatile coal and may be used as fuel only after lignite must be dried.

2. Due to high moisture of lignite and relative large granularity of crushed raw coal, relative long drying time is required; due to high content of volatile constituent of lignite, during drying at high temperature for long time, volatile constituent of lignite may be lost and effective constituent may be reduced, and when this situation become serious, self-ignition may occur.

3. In a drying process of lignite, the wet constituent to be removed is water, but some volatile constituent and dust may be produced. Because lignite is flammable and explosive medium, a dryer must be enclosed.

4. Waste gas resulted from drying high-moisture lignite has high humidity, it must prevent piping from dewing and blocking in a waste gas recovery system.

5. Although lignite has disadvantages of low coalification degree, high moisture and low calorific value, lignite has advantages of shallow burial layer and low price in comparison with full coal. In the present case that energy is increasing tight, to reduce moisture of lignite and improve coal quality of lignite has important strategy significance and wide market prospect on application.

Internationally, Japan has made outstanding achievement in lignite drying and application, and dry-type (bug) dust collecting is used. China has not succeeded in processes and facilities applied to lignite drying.

The relevant technology disclosed in China mainly focuses on hot-air direct drying, and protective technology for dust collecting system is also dry-type dust collecting, and these technologies are presented as follows:

A Chinese patent application No. 200810104399.2 disclosed a drying and upgrading device for lignite and a process thereof, which comprise a chamber dryer for lignite, a fluidized-bed pyrolysis device, a pyrolysed gas combustion device, and other auxiliary devices.

A Chinese patent application No. 200910060970.X disclosed a drying, forming and upgrading process for moisture-enriched lignite, which comprises steps of storing lignite, conveying lignite, crushing coal particles, rotary drum-shaped body multi-pipe drying, refined crushing, heating, hot pressing forming, screening and returning.

A Chinese patent application No. 200910119418.3 disclosed a drying and upgrading process for slime and lignite and a device thereof, which comprise: (1) pre-drying slime and lignite and feeding the pre-dried slime and lignite to a drying system in certain quantity; (2) drying and upgrading the pre-dried slime and lignite by the drying system; and (3) attaining a dried and upgraded coal.

### SUMMARY OF THE INVENTION

In view of the above description, an object of the present invention is to provide a drying process for drying lignite by swashing dust collection and washing. The process is combined with the characteristics of lignite, the material is dried with steam latent heat, and at the same time the dried waste gas is washed by a gravity settlement and swashing dust collection.

In order to achieve the object of the present invention, the present invention provides a drying process for drying lignite by swashing dust collection and washing, comprising steps of: conveying wet powdered coal into a steam-pipe rotary dryer by an feed belt so that the wet powdered coal is dried; introducing water steam for drying via a rotary joint at an outlet end of the dryer and into a heat exchange tube via a steam chamber; having the wet powdered coal contact and heat exchange with a steam pipe so that moisture contained in the wet powdered coal is continuously evaporated; discharging dried coal from a discharge port and conveying the dried coal to a subsequent station by a discharging belt; introducing condensed water resulted from steam heat exchange into a condensate pot via a rotating joint and then conveying the condensed water to a next station via a condensate pump; performing a primary dust collecting in a bin at a tail end of the dryer on waste gas produced during the drying process, discharging the waste gas from a top end of the bin and introducing the waste gas into a swashing dust collector; discharging waste liquid resulted from washing the waste gas from a bottom of the swashing dust collector, conveying the waste liquid discharged from the swashing dust collector via a waste liquid pump, wherein some of the waste liquid is conveyed to a waste gas pipe at the upstream of the swashing dust collector so as to be sprayed and the other of the waste liquid is conveyed to a waste liquid treatment station; and discharging the waste gas purified by the swashing dust collector with an induced draft fan.

The advantages of the present inventions are as follows:

(1) In the process of the present invention, a parallel operation is used, i.e., a carrying gas is not introduced, but the waste gas is discharged only by pumping of the system according to the present invention and the waste gas and the material flow in the same direction.

(2) In the process of the present invention, the system used is an enclosed system and drying atmosphere is close to one without oxygen, water steam is used as heat source medium of the lignite drying system, which assures to dry lignite at low temperature, prevents lignite from pyrolytic decomposition, avoids volatile constituent from lost and reduces risk of taking fire and explosion.

(3) The dried waste gas is pre-dust-collected in the gravity settling chamber and then washed and dust-collected by the swashing dust collector, so as to assure the waste gas is discharged after reaching a standard value and avoid the risk of taking fire and explosion occurred in a dry-type dust collecting way.

(4) A spraying system is provided in the waste gas pipe at the upstream of the swashing dust collector, which not only prevents the pipe from dewing and blocking but also functions as pre-dust collecting.

(5) With respect to an outlet of the swashing dust collector, spraying-type washing is performed with process water, which prevents from entraining dust.

(6) The swashing dust collector is provided with a demister at the outlet thereof, so as to prevent from entraining liquid droplet.

### BRIEF DESCRIPTION OF THE DRAWINGS

FIG. 1 is a schematic diagram of a process according to the present invention.

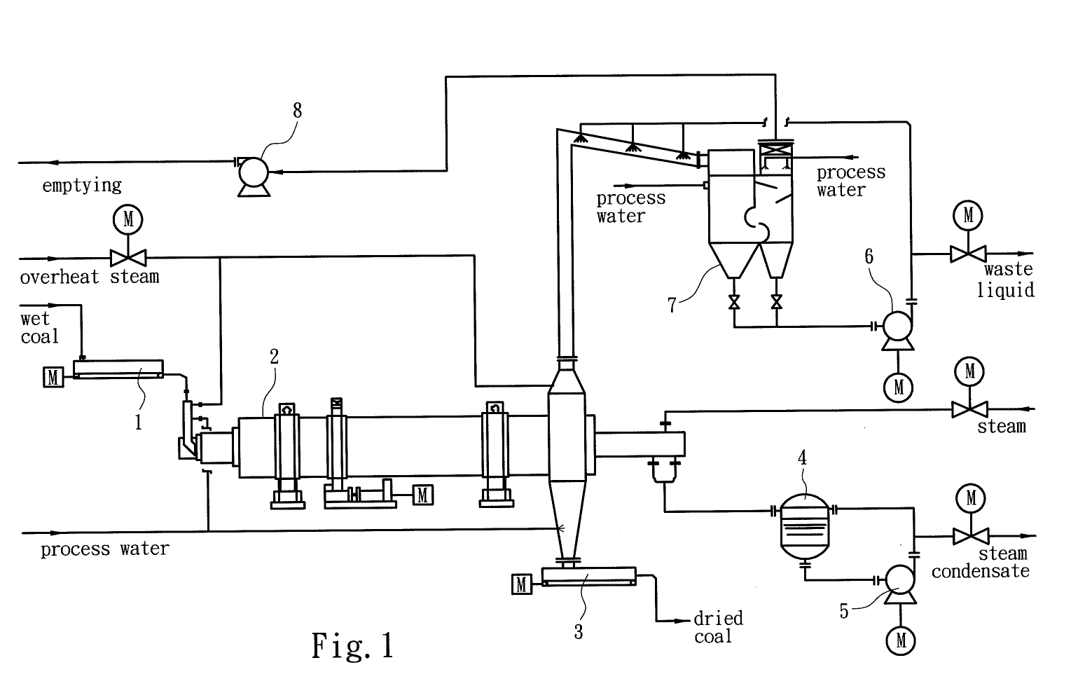

### DETAILED DESCRIPTION OF THE PREFERRED EMBODIMENTS

Hereinafter, the present invention will be further described with reference to the drawings. Wet powdered coal is conveyed into a steam-pipe rotary dryer 2 by a feed belt 1 so as to be dried. Water steam for drying is introduced via a rotary joint at an outlet end of the dryer and into a heat exchange tube via a steam chamber. The wet powdered coal is contacted and heat exchanged with a steam pipe so that moisture contained in the wet powdered coal is continuously evaporated. The dried coal is discharged from a discharge port and conveyed to a subsequent station by a discharging belt 3. Condensed water resulted from steam heat exchange is introduced into a condensate pot 4 via a rotating joint and then conveyed to a next station via a condensate pump 5. Waste gas produced during the drying process is performed a primary dust collecting in a bin (i.e. a gravity settling chamber) at a tail end of the steam-pipe rotary dryer, and then discharged from a top end of the bin and further into a swashing dust collector 7. The swashing dust collector 7 is provided with a demister at an outlet thereof, so as to prevent from entraining liquid droplet. The waste liquid after washing the waste gas is discharged from a bottom of the swashing dust collector 7. The waste liquid discharged from the swashing dust collector 7 is conveyed via a waste liquid pump 6, wherein some of the waste liquid is conveyed to a waste gas pipe at the upstream of the swashing dust collector 7 so as to be sprayed, the other of the waste liquid is conveyed to a waste liquid treatment station. The waste gas purified by the swashing dust collector 7 is discharged with an induced draft fan 8.

If an oxygen content of the waste gas after drying is over a standard value, steam is introduced from an inlet end of the dryer, so as to dilute air and reduce the oxygen content.

If a temperature of the dried coal is over a prescribed value, cooling water is introduced simultaneously from the inlet end and the outlet end of the dryer so as to reduce the temperature of the coal.

The dryer 2 is a stream-pipe rotary dryer, a heat-air rotary dryer or a heat flue gas heating-type rotary dryer.

An enclosed-type belt conveyor, a spiral conveyor or a rotary valve may be used to perform an feed process and an outlet process of the dryer.

What is claimed is:

1. A drying process for drying lignite by swashing dust collection and washing, comprising steps of:
conveying wet powdered coal into a steam-pipe rotary dryer (2) by an feed belt (1) so that the wet powdered coal is dried;
introducing water steam for drying via a rotary joint at an outlet end of the dryer and into a heat exchange tube via a steam chamber;
having the wet powdered coal contact and heat exchange with a steam pipe so that moisture contained in the wet powdered coal is continuously evaporated;
discharging dried coal from a discharge port and conveying the dried coal to a subsequent station by a discharging belt (3);
introducing condensed water resulted from steam heat exchange into a condensate pot (4) via a rotating joint and then conveying the condensed water to a next station via a condensate pump (5);
performing a primary dust collecting in a bin at a tail end of the dryer on waste gas produced during the drying process, discharging the waste gas from a top end of the bin and introducing the waste gas into a swashing dust collector (7);
discharging waste liquid resulted from washing the waste gas from a bottom of the swashing dust collector (7), conveying the waste liquid discharged from the swashing dust collector (7) via a waste liquid pump (6), wherein some of the waste liquid is conveyed to a waste gas piping at the upstream of the swashing dust collector (7) so as to be sprayed and the other of the waste liquid is conveyed to a waste liquid treatment station; and
discharging the waste gas purified by the swashing dust collector (7) with an induced draft fan (8).

2. The drying process for drying lignite by swashing dust collection and washing according to claim 1, wherein hot water, saturated steam, superheat steam, or heat conductive oil is used as a heat source.
